(19) United States
(12) Patent Application Publication
(10) Pub. No.: US 2026/0159417 A1
(43) Pub. Date: Jun. 11, 2026

(54) WATER TREATMENT DEVICE CAPABLE OF SELECTIVE RECOVERY OF SPECIFIC MAGNETIC FILTER LAYERS

(71) Applicants: KOREA INSTITUTE OF SCIENCE AND TECHNOLOGY, Seoul (KR); DAEGU GYEONGBUK INSTITUTE OF SCIENCE AND TECHNOLOGY, Daegu (KR)

(72) Inventors: Seong Pil JEONG, Seoul (KR); Seung Beum SUH, Seoul (KR); Kyungjin CHO, Seoul (KR); Kyung-Won JUNG, Seoul (KR); Suk Ho PARK, Gwangju (KR)

(21) Appl. No.: 19/401,854

(22) Filed: Nov. 26, 2025

(30) Foreign Application Priority Data
Dec. 9, 2024 (KR) 10-2024-0181585

(51) Int. Cl. C02F 1/00; C02F 1/28; C02F 1/48

(52) U.S. Cl. CPC C02F 1/001; C02F 1/28; C02F 1/488; C02F 2201/004; C02F 2201/48; C02F 2303/16; C02F 2305/08

(57) ABSTRACT

The present invention relates to a water treatment device capable of selective recovery of specific magnetic filter layers in which a plurality of magnetic filter layers are disposed to be spaced apart from each other in a reaction tank, and by applying a selective magnetic field to a specific magnetic filter layer, a magnetic filter layer located at a specific position is selectively recovered, thereby enabling recovery of only the magnetic filter layer where contaminants or target recovery materials are concentrated, so that backwash efficiency or recovery efficiency of the target recovery material may be improved.

### CROSS REFERENCE TO RELATED APPLICATION

The present application claims priority to Korean Patent Application No. 10-2024-0181585, filed Dec. 9, 2024, the entire contents of which are hereby incorporated by this reference.

### BACKGROUND OF THE INVENTION

### Field of the Invention

The present invention relates to a water treatment device capable of selective recovery of a specific magnetic filter layer(s), and more particularly, relates to a water treatment device capable of selective recovery of a specific magnetic filter layer(s), in which a plurality of magnetic filter layers are disposed to be spaced apart from each other in a reaction tank, and by applying a selective magnetic field to a specific magnetic filter layer, only the magnetic filter layer located at a specific position is selectively recovered, thereby enabling recovery of only the magnetic filter layer where contaminants or target recovery materials are concentrated, so that backwash efficiency or recovery efficiency of the target recovery material may be improved.

### [Description of Government-Sponsored Research]

This research was supported by the Ministry of Science and ICT of the Republic of Korea under the administration of the Korea Institute of Science and Technology, and (KIST), and the research project name is the Korea Institute of Science and Technology's research operating expenses support (R&D) (main project expense), and the research subject name is Complex Response Research Project on Atmospheric Environment (Climate and Environmental Fundamental Technology Development) (Subproject Number: 2710034011).

### Description of the Related Art

A process of supplying raw water to a reaction tank filled with filter media, and filtering contaminants included in the raw water or adsorbing target recovery materials included in the raw water onto the filter media, is widely used. In such a manner, generally, the reaction tank is installed in a vertical direction, and the raw water is supplied as an upward flow. Therefore, when operated for a certain period, a phenomenon occurs in which the contaminants or target recovery materials are concentrated in a filter layer of a region where the raw water flows in.

When the use of the filter media is adsorption of contaminants, a backwashing process is performed for desorption of contaminants, but as the backwashing process proceeds in a downward flow from an upper portion of the reaction tank, the backwash efficiency for a lower portion of the reaction tank, where the contaminants are concentrated, is inevitably reduced. In addition, when the use of the filter media is recovery of specific materials such as valuable metals, although the target recovery materials are concentrated in the filter layer of the lower portion of the reaction tank, since only the filter layer of the lower portion of the reaction tank cannot be selectively separated, an inefficiency occurs in that the entire filter layer inside the reaction tank must be separated from the reaction tank.

The above-described phenomenon has been explained by taking as an example the case in which the reaction tank is disposed in the vertical direction and the raw water is supplied as an upward flow, but even when the raw water is supplied as a downward flow, or when the reaction tank is disposed in a horizontal direction, the same phenomenon inevitably occurs.

### SUMMARY OF THE INVENTION

The present invention has been devised in order to solve the above-described problems, and has an object to provide a water treatment device capable of selective recovery of a specific magnetic filter layer(s), in which a plurality of magnetic filter layers are disposed to be spaced apart from each other in a reaction tank, and by applying a selective magnetic field to a specific magnetic filter layer, the magnetic filter layer located at a specific position is selectively recovered, thereby enabling recovery of only the magnetic filter layer where contaminants or target recovery materials are concentrated, so that backwash efficiency or recovery efficiency of the target recovery material may be improved.

In order to achieve the aforementioned object, there is provided a water treatment device capable of selective recovery of specific magnetic filter layers, according to the present invention. The water treatment device may comprise: a reaction tank providing a treatment space for raw water; first-stage magnetic filter layer to n-th-stage magnetic filter layer which are disposed to be spaced apart from each other along a vertical direction in an internal space of the reaction tank; first-stage magnetic field application device to n-th-stage magnetic field application device disposed corresponding to each stage of the magnetic filter layer and configured to apply a magnetic field to each stage of the magnetic filter layer; a magnetic filter medium recovery tank configured to store magnetic filter media discharged from the reaction tank; and a magnetic filter medium supply tank configured to supply magnetic filter media to a region of an uppermost magnetic filter layer, in which a specific magnetic filter layer may be configured to be moved to the magnetic filter medium recovery tank through selective magnetic field application to the first-stage magnetic filter layer to the n-th-stage magnetic filter layer.

The specific magnetic filter layer of being configured to be moved to the magnetic filter medium recovery tank through selective magnetic field application to the first-stage magnetic filter layer to the n-th-stage magnetic filter layer may be performed by: a first process of releasing a magnetic field applied to the first-stage magnetic filter layer in a state where magnetic fields are applied to all magnetic filter layers except the first-stage magnetic filter layer, to allow the first-stage magnetic filter layer to fall by gravity and move to the magnetic filter medium recovery tank; a second process of applying a magnetic field to a region of the first-stage magnetic filter layer through the first-stage magnetic field application device and simultaneously releasing the magnetic field applied to the second-stage magnetic filter layer, to allow the second-stage magnetic filter layer to fall by gravity and be fixed in a region of the first-stage magnetic filter layer; a third process of sequentially moving the third-stage magnetic filter layer to the n-th-stage magnetic filter layer to a region of a lower-stage magnetic filter layer through a method of the second process; and a fourth process of supplying magnetic filter media from the magnetic filter medium supply tank to a region of the n-th-stage magnetic filter layer to fill the region of the n-th-stage magnetic filter layer with magnetic filter media in a state where a magnetic field is applied to the region of the n-th-stage magnetic filter layer.

A magnetic filter medium discharge pipe spatially connected to the reaction tank may be provided between each stage of the magnetic filter layers, and a magnetic filter medium discharge pump may be provided at one side of the magnetic filter medium discharge pipe, and when a magnetic field applied to a specific-stage magnetic filter layer is released and simultaneously a magnetic filter medium discharge pump of a magnetic filter medium discharge pipe provided at a lower portion of the specific-stage magnetic filter layer is operated, the corresponding magnetic filter layer may fall by gravity and be discharged to the outside of the reaction tank through the magnetic filter medium discharge pipe by operation of the magnetic filter medium discharge pump.

Each stage of the magnetic filter layer may be an aggregate of magnetic filter media, and the magnetic filter media may comprise magnetic nanoparticles and filter media, and contaminants or target recovery materials included in the raw water may be adsorbed by the filter media, and the magnetic nanoparticles may serve to maintain a fixed state of the magnetic filter layer by magnetic force when a magnetic field is applied.

The water treatment device may further comprise: a raw water tank provided at one side of the reaction tank and configured to supply raw water to the reaction tank as an upward flow; and a treated water tank provided at another side of the reaction tank and configured to store treated water passing through the reaction tank.

The water treatment device capable of selective recovery of a specific magnetic filter layer(s) according to the present invention has the following effects.

Since only the magnetic filter layer in a raw water inflow region can be selectively recovered, the backwash efficiency or the recovery efficiency of the target recovery materials can be improved. In addition, through a method of sequentially moving each stage of the magnetic filter layer to a lower stage, the magnetic filter layers inside the reaction tank can be easily restored to a normal state, thereby minimizing the operation stop time (downtime) of the water treatment device.

### BRIEF DESCRIPTION OF THE DRAWINGS

FIG. 1 is a configuration diagram of a water treatment device capable of selective recovery of a specific magnetic filter layer(s) according to one embodiment of the present invention.

FIG. 2 is a configuration diagram of a water treatment device capable of selective recovery of a specific magnetic filter layer(s) according to another embodiment of the present invention.

FIGS. 3A, 3B, 3C and 3D are photographs of a water treatment device manufactured according to one embodiment of the present invention.

FIGS. 4A and 4B illustrate a core-shell structure and a mixed form of magnetic nanoparticles with filter medium for target material adsorption, respectively.

FIGS. 5A and 5B illustrate a core-shell structure and a mixed form of magnetic nanoparticles with filter medium for contaminant filtration, respectively.

### DETAILED DESCRIPTION OF THE INVENTION

The present invention proposes a technology capable of selectively recovering only the magnetic filter layer in a region where contaminants or target recovery materials are concentrated.

As mentioned in the section of “Description of the Related Art” above, the greatest problem in a process of filtering contaminants or target recovery materials from raw water using filter media is that the contaminants or target recovery materials are concentrated in the filter media of a region where the raw water flows in, and due to this phenomenon, the backwash efficiency or recovery efficiency is inevitably reduced.

The present invention configures magnetic filter layers in the reaction tank in multiple stages, and in a state in which magnetic field application devices for applying a magnetic field to each stage of the magnetic filter layer are independently disposed, makes the lowermost magnetic filter layer be recovered and, together with this, makes the upper-stage magnetic filter layers sequentially move to the region of the lower-stage magnetic filter layer through a method of selectively applying magnetic fields to each stage of the magnetic filter layer. Through this configuration, only the magnetic filter layer in which the contaminants or target recovery materials are concentrated may be selectively recovered, and since the replenishment of the recovered magnetic filter layer is performed by a very simple method, the operation stop time of the water treatment device may be minimized.

Hereinafter, a water treatment device capable of selective recovery of a specific magnetic filter layer(s) according to one embodiment of the present invention will be described in detail with reference to the drawings.

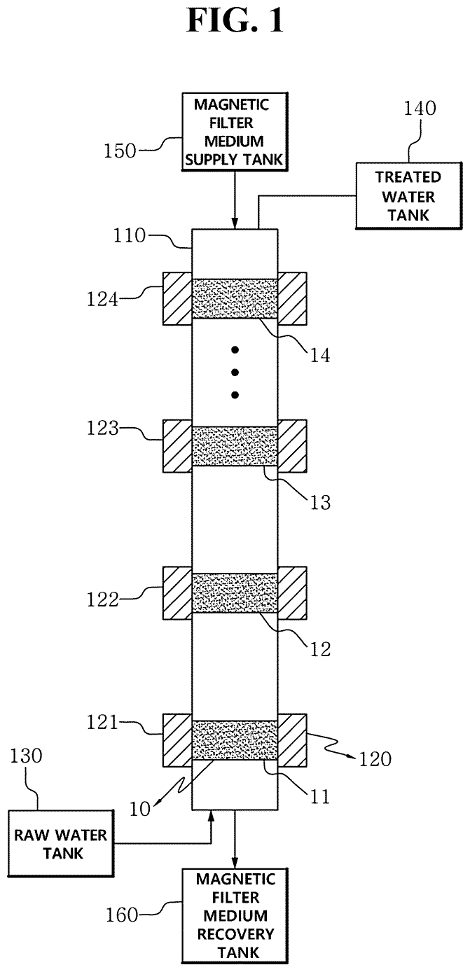

With reference to FIG. 1, the water treatment device capable of selective recovery of a specific magnetic filter layer(s) according to one embodiment of the present invention includes a reaction tank 110.

The reaction tank 110 provides a space in which multi-stage magnetic filter layers 10 are mounted. Inside the reaction tank 110, the multi-stage magnetic filter layers 10 are disposed to be spaced apart along a vertical direction. For example, a first-stage magnetic filter layer 11, a second-stage magnetic filter layer 12, ..., and an n-th-stage magnetic filter layer 14 may be disposed to be spaced apart along the vertical direction inside the reaction tank 110.

Each stage of the magnetic filter layer 10 is formed of an aggregate of magnetic filter media. That is, a plurality of magnetic filter media form an aggregate to constitute the magnetic filter layer 10. The magnetic filter medium is composed of magnetic nanoparticles and a filter medium, and the filter medium serves to filter contaminants included in the raw water or to adsorb target recovery materials included in the raw water. In addition, the magnetic nanoparticles serve to maintain a fixed state of the magnetic filter layer 10 by magnetic force when a magnetic field is applied.

The magnetic filter medium has no limitation in form as long as it is composed of a combination of magnetic nanoparticles and a filter medium. In one embodiment, the magnetic filter medium may have a so-called core-shell structure in which the filter medium is provided on the surface of the magnetic nanoparticles, or may have a mixed form in which the magnetic nanoparticles and the filter medium are mixed together.

In the case where the magnetic filter medium has the core-shell structure and is used for adsorption of target recovery materials, the filter medium may be provided with a specific functional group(s) or a specific nanoparticle(s) capable of selectively adsorbing the target recovery materials. In addition, in the case where the magnetic nanoparticles and the filter medium form a mixed form, the filter medium forms a carrier, and the magnetic nanoparticles may be provided such that they are mixed within the carrier, and in this case, when used for adsorption of target recovery materials, a specific functional group(s) or a specific nanoparticle(s) having adsorption capability for the target recovery materials may be fixed on the carrier.

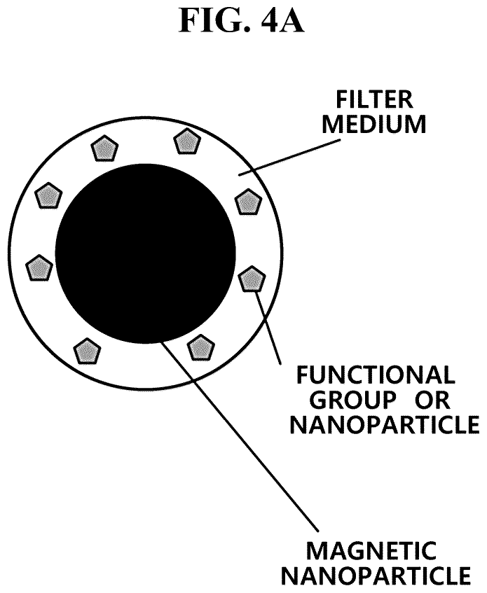

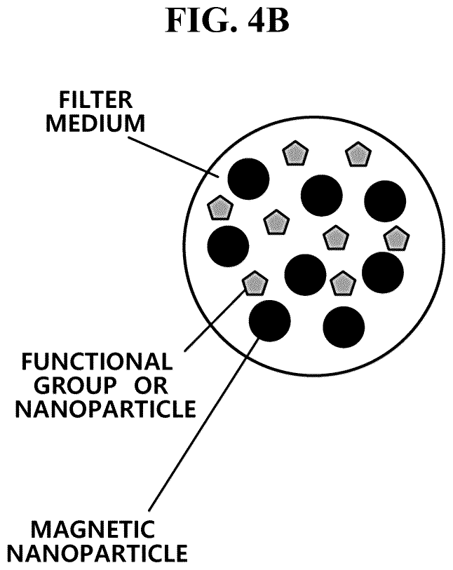

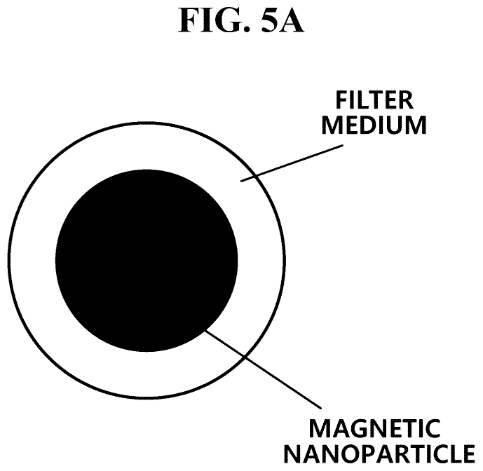

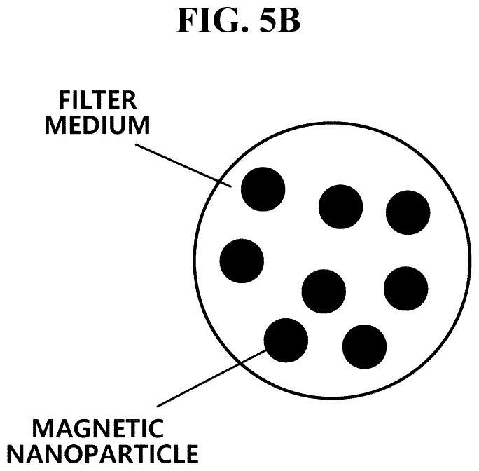

Meanwhile, when the magnetic filter medium is used for filtration of contaminants, the specific functional group(s) or specific nanoparticle(s) having adsorption capability for the target recovery materials are not fixed to the filter medium, but instead, a coating layer for preventing membrane fouling may be provided on the surface of the filter medium. In FIGS. 4A and 4B, the core-shell structure of the magnetic filter medium and the mixed form of the magnetic nanoparticles and the filter medium used for adsorption of target recovery materials are respectively illustrated, and in FIGS. 5A and 5B, the core-shell structure of the magnetic filter medium and the mixed form of the magnetic nanoparticles and the filter medium used for filtration of contaminants are respectively illustrated. In addition, as another form of the magnetic filter medium, it is also possible to form a layered structure in which layers of the filter media and layers of the magnetic nanoparticles are alternately laminated.

The filter medium has no limitation in material composition as long as it has adsorption capability for the target recovery materials. In one embodiment, the filter medium may be formed of a polymer material or a metal oxide having adsorption capability for organic contaminants, or may be formed of various materials having adsorption capability for heavy metal ions, or may be formed of a material having adsorption capability for rare-earth metals such as lithium.

In each stage region where the magnetic filter layer 10 is provided, a magnetic field application device 120 configured to selectively apply a magnetic field to the corresponding region is provided. That is, the multi-stage magnetic filter layers 10 are disposed to be spaced apart along a vertical direction in an internal space of the reaction tank 110, and a magnetic field application device 120 is provided in a horizontal direction of each stage of the magnetic filter layer 10 corresponding thereto. Accordingly, a magnetic field may be independently and selectively applied to each stage of the magnetic filter layer 10. In one embodiment, each stage of the magnetic field application device 120 may be provided outside the reaction tank 110. Also, on the premise that magnetic force is sufficiently generated by the magnetic field of the magnetic field application device 120, each stage of the magnetic field application device 120 may be provided to be attached to an outer surface of the reaction tank 110, or may be provided to be spaced apart from the outer surface of the reaction tank 110 by a predetermined distance.

Under such a configuration, by selectively applying a magnetic field to each stage of the magnetic filter layer 10, each stage of the magnetic filter layer 10 may be moved. This will be described in more detail below.

In a state where from a lower portion of the reaction tank 110 toward an upper portion, a first-stage magnetic filter layer 11, a second-stage magnetic filter layer 12, ..., and an n-th-stage magnetic filter layer 14 are disposed to be spaced apart, and in correspondence to each stage of the magnetic filter layer 10, a first-stage magnetic field application device 121, a second-stage magnetic field application device 122, ..., and an n-th-stage magnetic field application device 124 are provided, when a magnetic field is applied by the first-stage magnetic field application device 121 that applies a magnetic field to the first-stage magnetic filter layer 10, magnetic force is generated by the magnetic nanoparticles of the magnetic filter medium, so that the first-stage magnetic filter layer 11 forms a fixed state in the corresponding region. In contrast, when the magnetic field generated from the first-stage magnetic field application device 121 is released, since the magnetic force between the magnetic nanoparticles disappears, the magnetic filter media forming the first-stage magnetic filter layer 11 fall by gravity. Through such a method, each stage of the magnetic filter layer 10 may be fixed in a region of the corresponding magnetic filter layer 10, or may be caused to fall by gravity.

Meanwhile, the raw water is supplied as an upward flow to the reaction tank 110, and the contaminants or target recovery materials included in the raw water are adsorbed onto the magnetic filter layer 10 inside the reaction tank 110. In this case, as the raw water is supplied as an upward flow, the contaminants or target recovery materials are concentrated in and adsorbed onto the magnetic filter layer 10 in a region where the raw water flows in, for example, the first-stage magnetic filter layer 10.

Accordingly, when the process is operated for a certain period, the first-stage magnetic filter layer 10 may be clogged by contaminants or be broken by target recovery materials, and by applying the above-described movement principle of the magnetic filter layer 10, the first-stage magnetic filter layer 10 may be discharged from the reaction tank 110 and recovered.

Specifically, in a state in which magnetic fields are applied to all magnetic filter layers 10 except for the first-stage magnetic filter layer 11, the magnetic field applied to the first-stage magnetic filter layer 11 is released. Accordingly, the first-stage magnetic filter layer 11 falls by gravity and is discharged to an outside of the reaction tank 110. Outside the reaction tank 110, a magnetic filter medium recovery tank 160 is provided, and the magnetic filter media forming the first-stage magnetic filter layer 11, which has been discharged to the outside of the reaction tank 110, is moved to the magnetic filter medium recovery tank 160.

In such a state, while a magnetic field is applied to a region of the first-stage magnetic filter layer 11 through the first-stage magnetic field application device 121, the magnetic field applied to the second-stage magnetic filter layer 12 is released. Accordingly, the second-stage magnetic filter layer 12 falls by gravity, and since the magnetic field is applied to the region of the first-stage magnetic filter layer 11, the second-stage magnetic filter layer 12 that falls by gravity is fixed in the region of the first-stage magnetic filter layer 11, thereby forming the first-Stage magnetic filter layer 11.

Through this method, it is possible that the third-stage magnetic filter layer 13 is moved to the second-stage magnetic filter layer 12, and the fourth-stage magnetic filter layer 10 is moved to the third-stage magnetic filter layer 13. Meanwhile, as a result, no magnetic filter media remain in a region of the n-th-stage magnetic filter layer 14; in this case, while a magnetic field is applied to the region of the n-th-stage magnetic filter layer 14, magnetic filter media are supplied from a magnetic filter medium supply tank 150 to the region of the n-th-stage magnetic filter layer 14 so that the n-th-stage magnetic filter layer 14 may be formed.

Through the method described above, the lowermost magnetic filter layer 10, for example, the first-stage magnetic filter layer 11, may be recovered to the outside of the reaction tank 110, and simultaneously, through the sequential movement of the magnetic filter layers 10 and the supply of magnetic filter media from the magnetic filter medium supply tank 150, each stage of the magnetic filter layer 10 inside the reaction tank 110 may be maintained in a normal state. Here, although the above description has been made focusing on the recovery of the first-stage magnetic filter layer 11, it is of course possible to recover the first-stage magnetic filter layer 11 and the second-stage magnetic filter layer 12 together through selective application of magnetic fields.

Through the method described above, only the magnetic filter layer 10 in the raw water inflow region, in which contaminants or target recovery materials are concentrated and adsorbed, may be selectively recovered, thereby improving backwash efficiency during backwashing of the magnetic filter layer 10, and increasing recovery efficiency during recovery of target recovery materials.

Meanwhile, on one side of the reaction tank 110, a raw water tank 130 for supplying raw water to the reaction tank 110 as an upward flow is provided, and on the other side of the reaction tank 110, a treated water tank 140 for storing treated water that has passed through the reaction tank 110 is provided. In addition, on one side of the reaction tank 110, for example, on a lower portion of the reaction tank 110, a magnetic filter medium recovery tank 160 for storing magnetic filter media discharged from the reaction tank 110 is provided, and on the other side of the reaction tank 110, for example, on an upper portion of the reaction tank 110, a magnetic filter medium supply tank 150 for supplying magnetic filter media to a region of the uppermost magnetic filter layer 10 may be provided.

In the above-described embodiment, it has been described that the lowermost magnetic filter layer 10, for example, the first-stage magnetic filter layer 11, is discharged to the outside of the reaction tank 110 by falling by gravity. However, in another embodiment, it is also possible to allow magnetic filter layers 10 other than the first-stage magnetic filter layer 11 to be discharged to the outside of the reaction tank 110.

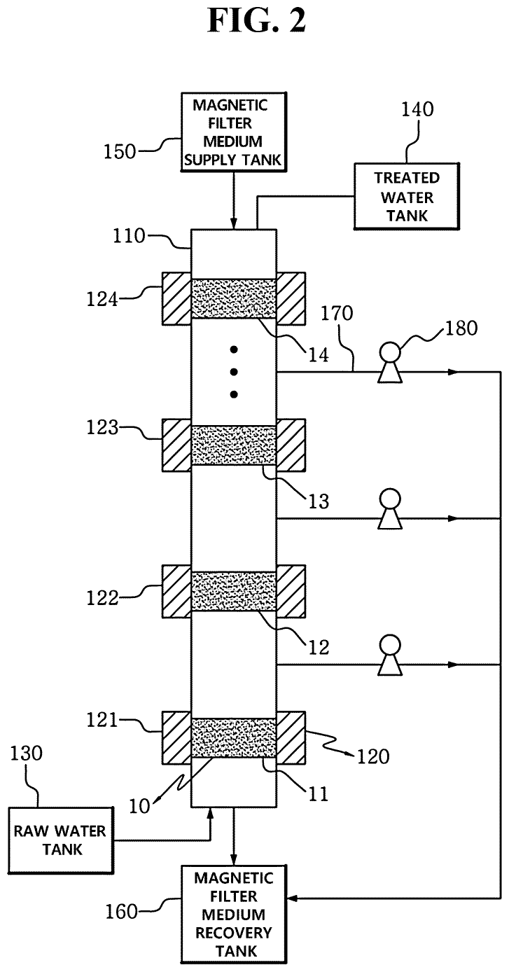

In this case, as illustrated in FIG. 2, a magnetic filter medium discharge pipe 170 spatially connected to the reaction tank 110 is provided between each stage of the magnetic filter layers 10, and a magnetic filter medium discharge pump 180 is provided on one side of the magnetic filter medium discharge pipe 170. For example, one or more magnetic filter medium discharge pipes 170 in a form of being branched from the reaction tank 110 are provided, and a branching point of each magnetic filter medium discharge pipe 170 is a region between neighboring magnetic filter layers 10.

Under such a configuration, when the magnetic field applied to a specific-stage magnetic filter layer 10 is released and, simultaneously, the magnetic filter medium discharge pump 180 provided at a lower portion of the specific-stage magnetic filter layer 10 and connected to the magnetic filter medium discharge pipe 170 is operated, the corresponding magnetic filter layer 10 may fall by gravity and, due to operation of the magnetic filter medium discharge pump 180, may be discharged to the outside of the reaction tank 110 through the magnetic filter medium discharge pipe 170. In this case, for smooth discharge into the magnetic filter medium discharge pipe 170, it is preferable that the magnetic filter medium discharge pipe 170 be disposed in a downwardly inclined form rather than disposed horizontally. Additionally, a plurality of magnetic filter medium discharge pipes 170 disposed at each stage may be provided on the same horizontal line.

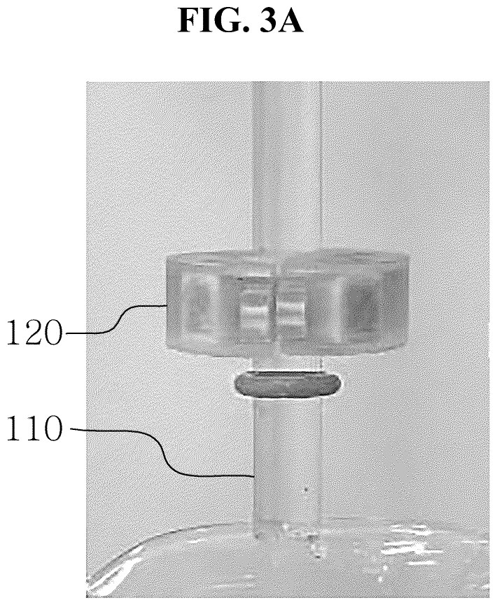

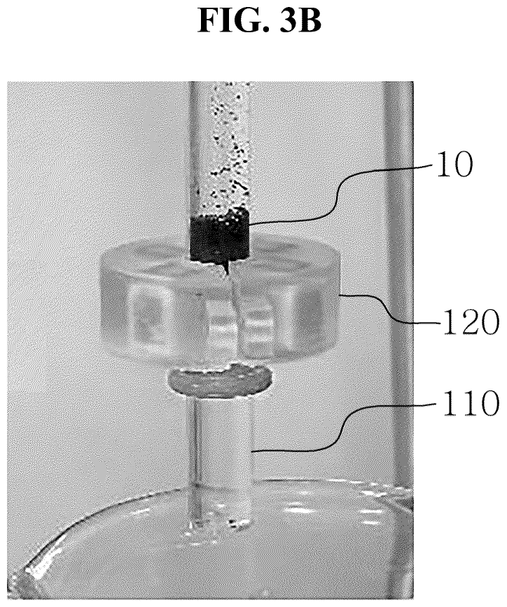

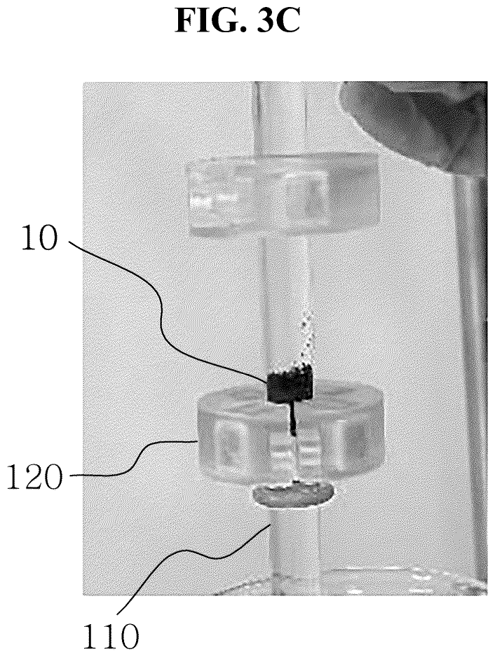

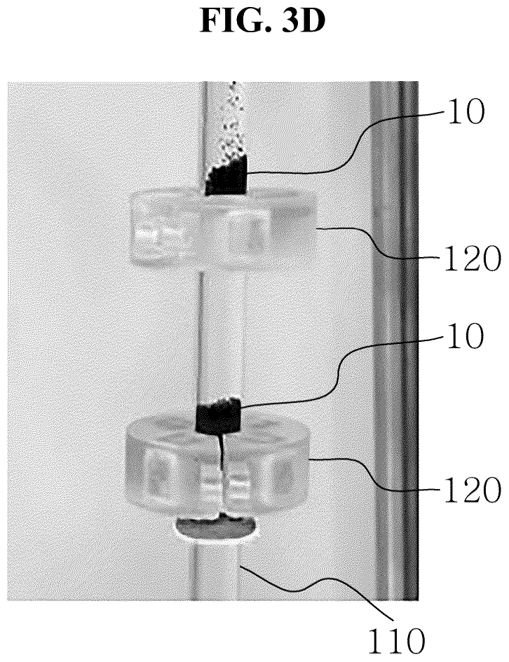

FIGS. 3A, 3B, 3C and 3D are photographs of a water treatment device manufactured according to one embodiment of the present invention. In FIG. 3A, a state in which a magnetic field is applied to a region of a specific-stage magnetic filter layer 10 is illustrated, in FIG. 3B, a state in which the magnetic filter media are fixed when the magnetic filter media are supplied to form the specific-stage magnetic filter layer 10 is illustrated, in FIG. 3C, a state in which an upper-stage magnetic filter layer 10 has fallen by gravity due to release of the magnetic field and has been fixed in a region of a lower-stage magnetic filter layer 10 is illustrated, and in FIG. 3D, a state in which the supplied magnetic filter media are fixed by the magnetic field to form an upper-stage magnetic filter layer 10 is illustrated.

Description of Reference Numerals

| | |
|---|---|
| 10: Magnetic filter layer | 11: First-stage magnetic |
| | filter layer |
| 12: Second-stage magnetic | 13: Third-stage magnetic |
| filter layer | filter layer |
| 14: N-th-stage magnetic | |
| filter layer | |
| 110: Reaction tank | 120: Magnetic field |
| | application device |
| 121: First-stage magnetic | |
| field application device | |
| 122: Second-stage magnetic | |
| field application device | |
| 123: Third-stage magnetic | |
| field application device | |
| 124: N-th-stage magnetic | |
| field application device | |
| 130: Raw water tank | 140: Treated water tank |
| 150: Magnetic filter | |
| medium supply tank | |
| 160: Magnetic filter | |
| medium recovery tank | |
| 170: Magnetic filter | |
| medium discharge pipe | |
| 180: Magnetic filter | |
| medium discharge pump | |

What is claimed is:

1. A water treatment device capable of selective recovery of a specific magnetic filter layer, comprising:
a reaction tank providing a treatment space for raw water;
first-stage magnetic filter layer to n-th-stage magnetic filter layer which are disposed to be spaced apart from each other along a vertical direction in an internal space of the reaction tank;
first-stage magnetic field application device to n-th-stage magnetic field application device disposed corresponding to each stage of the magnetic filter layer and configured to apply a magnetic field to each stage of the magnetic filter layer;
a magnetic filter medium recovery tank configured to store magnetic filter media discharged from the reaction tank; and
a magnetic filter medium supply tank configured to supply magnetic filter media to a region of an uppermost magnetic filter layer,
wherein a specific magnetic filter layer is configured to be moved to the magnetic filter medium recovery tank through selective magnetic field application to the first-stage magnetic filter layer to the n-th-stage magnetic filter layer.

2. The water treatment device of claim 1, wherein the specific magnetic filter layer of being configured to be moved to the magnetic filter medium recovery tank through selective magnetic field application to the first-stage magnetic filter layer to the n-th-stage magnetic filter layer is performed by:
a first process of releasing a magnetic field applied to the first-stage magnetic filter layer in a state where magnetic fields are applied to all magnetic filter layers except the first-stage magnetic filter layer, to allow the first-stage magnetic filter layer to fall by gravity and move to the magnetic filter medium recovery tank;
a second process of applying a magnetic field to a region of the first-stage magnetic filter layer through the first-stage magnetic field application device and simultaneously releasing the magnetic field applied to the second-stage magnetic filter layer, to allow the second-stage magnetic filter layer to fall by gravity and be fixed in a region of the first-stage magnetic filter layer;
a third process of sequentially moving the third-stage magnetic filter layer to the n-th-stage magnetic filter layer to a region of a lower-stage magnetic filter layer through a method of the second process; and
a fourth process of supplying magnetic filter media from the magnetic filter medium supply tank to a region of the n-th-stage magnetic filter layer to fill the region of the n-th-stage magnetic filter layer with magnetic filter media in a state where a magnetic field is applied to the region of the n-th-stage magnetic filter layer.

3. The water treatment device of claim 1, wherein a magnetic filter medium discharge pipe spatially connected to the reaction tank is provided between each stage of the magnetic filter layers,
a magnetic filter medium discharge pump is provided at one side of the magnetic filter medium discharge pipe, and
when a magnetic field applied to a specific-stage magnetic filter layer is released and simultaneously a magnetic filter medium discharge pump of a magnetic filter medium discharge pipe provided at a lower portion of the specific-stage magnetic filter layer is operated,
the corresponding magnetic filter layer falls by gravity and is discharged to the outside of the reaction tank through the magnetic filter medium discharge pipe by operation of the magnetic filter medium discharge pump.

4. The water treatment device of claim 1, wherein each stage of the magnetic filter layer is an aggregate of magnetic filter media, and the magnetic filter media comprise magnetic nanoparticles and filter media, and
contaminants or target recovery materials included in the raw water are adsorbed by the filter media, and the magnetic nanoparticles serve to maintain a fixed state of the magnetic filter layer by magnetic force when a magnetic field is applied.

5. The water treatment device of claim 1 further comprising:
a raw water tank provided at one side of the reaction tank and configured to supply raw water to the reaction tank as an upward flow; and
a treated water tank provided at another side of the reaction tank and configured to store treated water passing through the reaction tank.
